(19) United States
(12) Patent Application Publication
(10) Pub. No.: US 2002/0005839 A1
(43) Pub. Date: Jan. 17, 2002

(54) Setup condition input device and image forming apparatus

(76) Inventor: Masami Nojiri, Ibaraki-ken (JP)

Correspondence Address: NATH & ASSOCIATES, Sixth Floor, 1030 Fifteenth Street, N.W., Washington, DC, 20005, US

(21) Appl. No.: 09/870,651

(22) Filed: Jun. 1, 2001

(30) Foreign Application Priority Data
Jun. 5, 2000 (JP) P2000-167769

(51) Int. Cl. G09G 5/00

(52) U.S. Cl. 345/173

(57) ABSTRACT

An input unit device is constructed of a setup screen of a multi-stage type to enable conditions to be input, a setup confirmation screen for displaying the setup conditions in a package, a memory registration command section for allowing the setup conditions to be stored in memories and a memory call-up command section for allowing the setup conditioned to be called up from the memory for reuse. The memory registration command section is located on the setup confirmation screen. An image forming apparatus reads out setup image reproducing conditions stored in the setup condition input device for reproducing the image.

### BACKGROUND OF THE INVENTION

The present invention relates to a setup condition input device and an image forming apparatus which allow desired images to be reproduced on print sheets and, more particularly, to a setup condition input device and an image forming apparatus employing the same for providing an improved man/machine interface.

In general, an image forming apparatus such as a printing machine or a copying machine are constructed to have various functions that enable setup of functions such as, for example, the number of print sheets to be printed, a print density, a scale-down/scale-up and a sorter (image reproducing conditions).

It has heretofore been proposed to provide setup a condition input device as a setup system for setting up the aforementioned functions with the use of an operation panel on which groups of plurality of switches and associated groups of LEDs (Light Emitting Diodes) are located in parallel to one another, with each switch being assigned for each function. A schematic block diagram for such a parallel configuration is illustrated in FIG. 12A.

The setup condition input device ID, shown in FIG. 12A, has a plurality of function setup screens SF1 to SF4 that are located in parallel to one another. In such a parallel configuration, if the number of switches increases with an increase in the number of functions, then a problem is encountered in the operation panel owing to its inherent limited regional area, with undesirable complicated operations being inevitably imposed. To address this issue, it may be thought to provide a setup condition input device of a multi-stage type shown in FIG. 12B. To realize such a setup condition input device of the multi-stage type, the input device ID′ is constructed of a touch panel type input device which has a display such as, for example, a liquid crystal display device whose front face is placed with a transparent panel to allow an operator's finger to directly touch the same to execute pointing. Such a touch panel type input device employs a system wherein an upper face of the display device is placed with a panel of a pressure sensitive type or of an electrostatic type to allow a positional information to be detected upon the operator's touching, with the positional information being inputted to a CPU. More particularly, the input device ID′ includes a main menu screen MM, which has sub-menu screens SM1 and SM2. The sub-menu screens SM1 has setup function screens SF1 to SF3, and the sub-menu screen SM2 has setup function screens SF4 and SF5. Likewise, the setup function screen SF3 has setup function screens SF3a and SF3b. The setup function screen SF3b has setup function screens SF3b-1 and SF3b-2. Such an input device is advantageous in that everybody can simply operate the input device and it is possible to realize the setup condition input device of the multi-stage type by using the operation panel with a limited surface area.

### SUMMARY OF THE INVENTION

However, due to the further studies done by the inventor of the present invention, there is a need for storing the setup conditions in memories and retrieving the stored setup conditions from the memories for reusing the same. To this end, it can be thought to provide an input unit having a memory registration function. In particular, in such a stencil printing machine wherein a multi-color printing is implemented with the use of separate stencil sheets, since it is required to provide various setup patterns depending on the kind of print sheets and the input device should require extremely and highly accurate set values such as a print position, etc., it is highly effective for the input device to have the memory registration function which allows the setup conditions, which have been set once, to be stored and to be reused.

In such an input device having the memory registration function, however, since the memory registration is executed through the uppermost screen (for example, the main menu screen, etc.) of the multi-stage structure or through respective setup screens of the multi-stage structure for setting up the conditions, an operator encounters a problem in that it is difficult for him to execute the memory registration while fully recognizing all items, for which the setup conditions are inputted (involving, for example, the conditions which have been setup in a deeper level of the multi-stage or the set values which have been setup in trees different from one another). These difficulties tend to become more serious with the increase in the number of multi-functions and with the increase in the complication of the setup conditions.

The present invention has been achieved with the above-stated studies. It is, therefore, an object of the present invention to provide a setup condition input device and a image forming apparatus employing the same wherein a command section for a memory registration is located on a setup confirmation screen adapted to provide a display of various set values to allow an operator to execute the memory registration while fully recognizing all the items of conditions setup by the operator.

To obtain the above-stated object, a setup condition input device of the present invention is provided with: a setup screen of a multi-stage type allowing predetermined conditions to be set up; a setup confirmation screen allowing the predetermined conditions set up through the setup screen to be displayed in a package for confirmation; and a memory registration command section allowing the predetermined conditions confirmed through the setup confirmation screen to be stored in memories. The memory registration command section is located on the setup confirmation screen.

Besides, an image forming apparatus of the present invention is provided with: a setup condition input device having a setup screen of a multi-stage type allowing predetermined conditions to be set up, a setup confirmation screen allowing the predetermined conditions set up through the setup screen to be displayed in a package for confirmation, and a memory registration command section allowing the predetermined conditions confirmed through the setup confirmation screen to be stored in memories, the memory registration command section being located on the setup confirmation screen; and an image forming unit forming image on basis of the predetermined conditions stored in the setup condition input device and read out thererfrom.

Other and further features, advantages, and benefits of the present invention will become more apparent from the following description taken in conjunction with the following drawings.

### BRIEF DESCRIPTION OF THE DRAWINGS

FIG. 1 is a schematic view illustrating the principles of a preferred embodiment of a setup condition input device according to the present invention;

FIG. 2 is a block diagram of the preferred embodiment of the setup condition input device according to the embodiment;

FIG. 3 is an example of a layout of an operation panel that is applied to an image forming apparatus such as a stencil printing machine employing the setup condition input device according to the embodiment;

FIG. 4 is an enlarged schematic view illustrating an example of a setup screen forming part of the setup condition input device according to the embodiment;

FIG. 5 is an enlarged schematic view illustrating an example of a setup confirmation screen forming part of the setup condition input device according to the embodiment;

FIG. 6 is an enlarged schematic view illustrating an example of a memory registration screen forming part of the setup condition input device according to the embodiment;

FIGS. 7A to 7C are schematic views illustrating the basic sequence of operations showing how a display is performed from the setup screen to the memory registration screen through the setup confirmation screen according to the embodiment;

FIGS. 8A to 8F are schematic views illustrating the basic principle of operations for executing memory registration through the memory registration screen shown in FIG. 7C;

FIGS. 9A to 9C are schematic views illustrating the basic principle of operations of a memory call-up operation (i.e., for shifting to a memory call-up screen) for calling up and reusing the setup conditions and set values stored in the memories according to the embodiment;

FIGS. 10A to 10D are schematic views illustrating the basic principle of operations of a memory call-up operation (i.e., for executing a memory call-up process) for calling up and reusing the setup conditions and set values stored in the memories according to the embodiment;

FIGS. 11A and 11B are schematic views illustrating the basic principle of operations of a memory call-up operation (i.e., for executing change-over of pages) for calling up and reusing the setup conditions and set values stored in the memories according to the embodiment;

FIGS. 12A and 12B are schematic views illustrating general principles of setup condition input devices studied by the present inventor; and

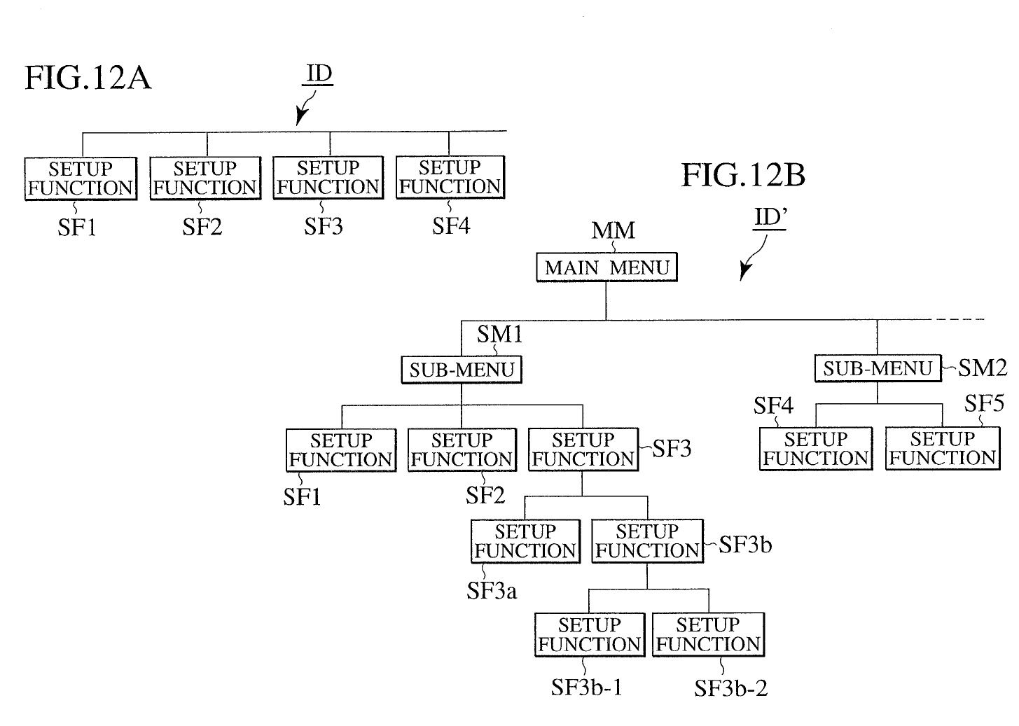

FIG. 13 is a schematic, structural view of a stencil printing machine to which the setup condition input device of the present invention is applied.

### DETAILED DESCRIPTION OF THE PREFERRED EMBODIMENT

An preferred embodiment of a setup condition input device and an image forming apparatus according to the present invention will be described hereinafter in detail with reference to FIGS.

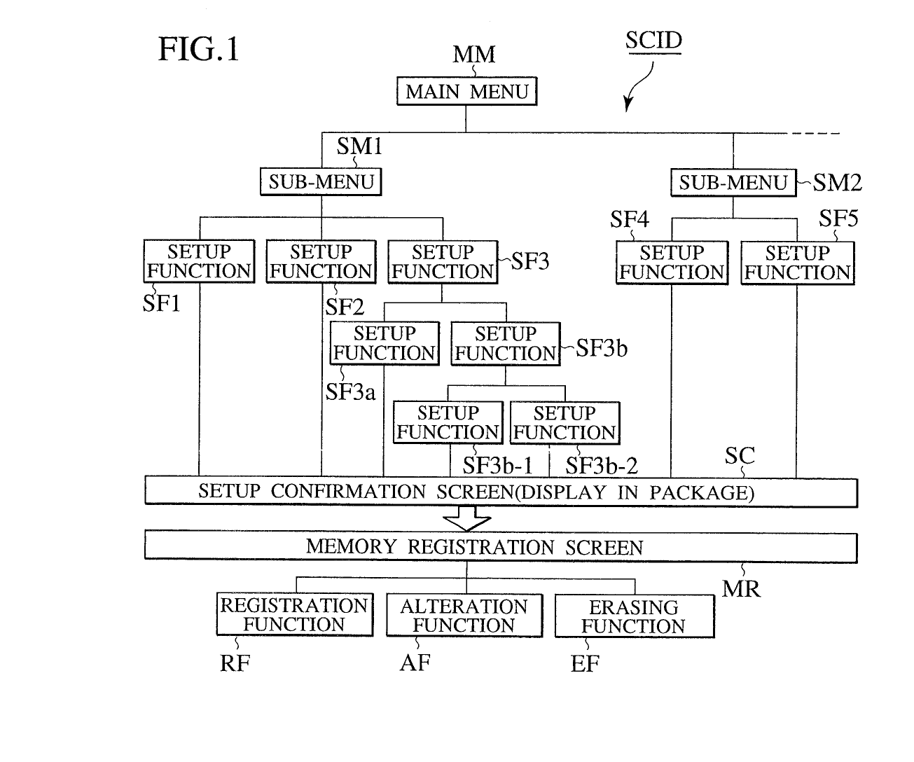

Referring now to FIG. 1, there is schematically shown a principal structure of a setup condition input device of the preferred embodiment. In FIG. 1, the setup condition input device, generally designated at SCID, is constructed of a multi-stage structure that contains a plurality of setup screens to allow various conditions to be set up. The setup condition input device includes a main menu screen MM which is located on an uppermost stage of a setup program, and sub-menu screens SM1 and SM2 which are located in a next stage of the setup program. The main menu screen MM is composed of a menu screen to enable classification of large groups such as, for example, a basic function and an expanded function. The sub-menu screens SM1 and SM2 are composed of menu screens to enable classification of medium groups such as, for example, application functions and specialized functions of the expanded function group, respectively. The sub-menu screen SM1 has three discrete function setup screens SF1, SF2 and SF3, and the sub-menu screen SM2 has two function setup screens SF4 and SF5. The function setup screen F3 has two function setup screens SF3a and SF3b, with the function setup screen SF3b having two function setup screens SF3b-1 and SF3b-2. In this manner, the function setup screens are discretely expanded in multi-stage fashions for allowing various parameters to be set up.

The setup condition input device further includes a setup confirmation screen SC for displaying all the setup conditions and set values thereof in a package, and the setup confirmation screen is enabled to be called up at any time from each setup screen or from a higher stage menu screen.

The setup condition input device also includes a memory registration screen MR which allows setup conditions and their setup values to be newly registered in memories and which may be shifted from each of the setup confirmation screen. Also, another route may be prepared to cause the memory registration screen to be shifted from the menu screen or from the respective setup screens. The memory registration screen MR has a registration function RF to allow the setup conditions and recognition screen MR has a recognition function RF to allow the setup conditions and the set values to be registered in memories, an alteration function AF to allow a title of information, which has been previously registered, to be altered, and an erasing function EF to allow setup conditions and their set values, which have been registered, to be erased.

Although as described later, the setup condition input device may also include a memory call-up function to enable the setup conditions and the set values, which have been stored in the memory, to be called up for reuse.

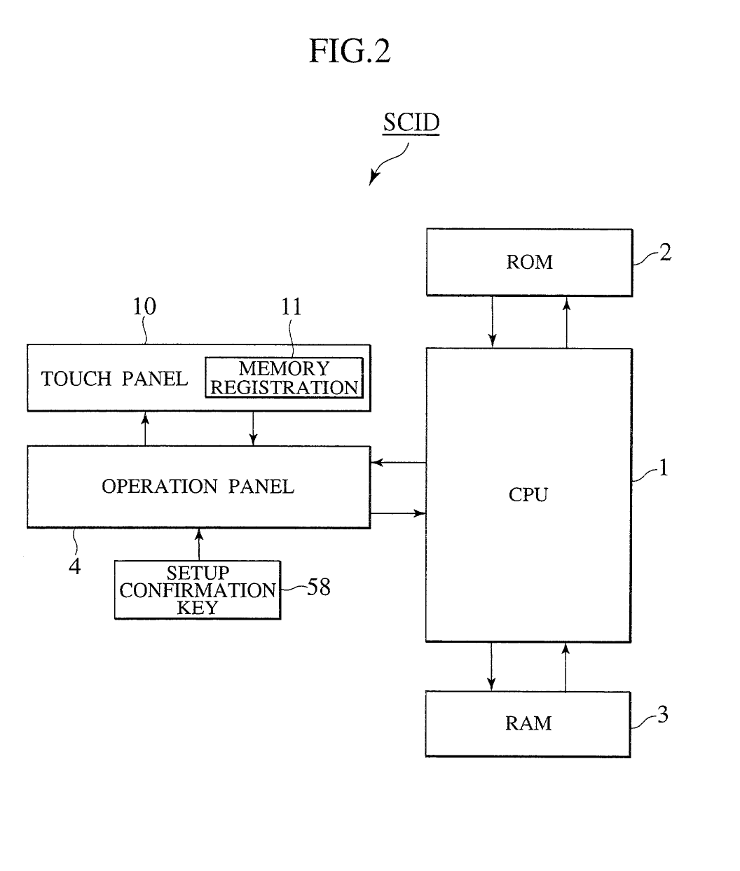

Referring to FIG. 2, there is schematically shown a block diagram of the setup condition input device SCID. The setup condition input device SCID includes a ROM (Read Only Memory) 2 which stores a control program for controlling the setup condition input device and various data to be displayed on the setup screens, a CPU (Central Processing unit)1, a non-volatile RAM (Random Access Memory) 3 which stores setup conditions and the setup values, and a operation panel 4. The operation panel 4 is constructed of a touch panel 10 of a pressure sensitive type or of an electrostatic type, from which various parameters can be inputted directly with an operator's fingers. Also, the CPU 1, the ROM 2 and the RAM 3 may be replaced with a main CPU or a memory of an image reproducing apparatus on which the setup condition input device is installed.

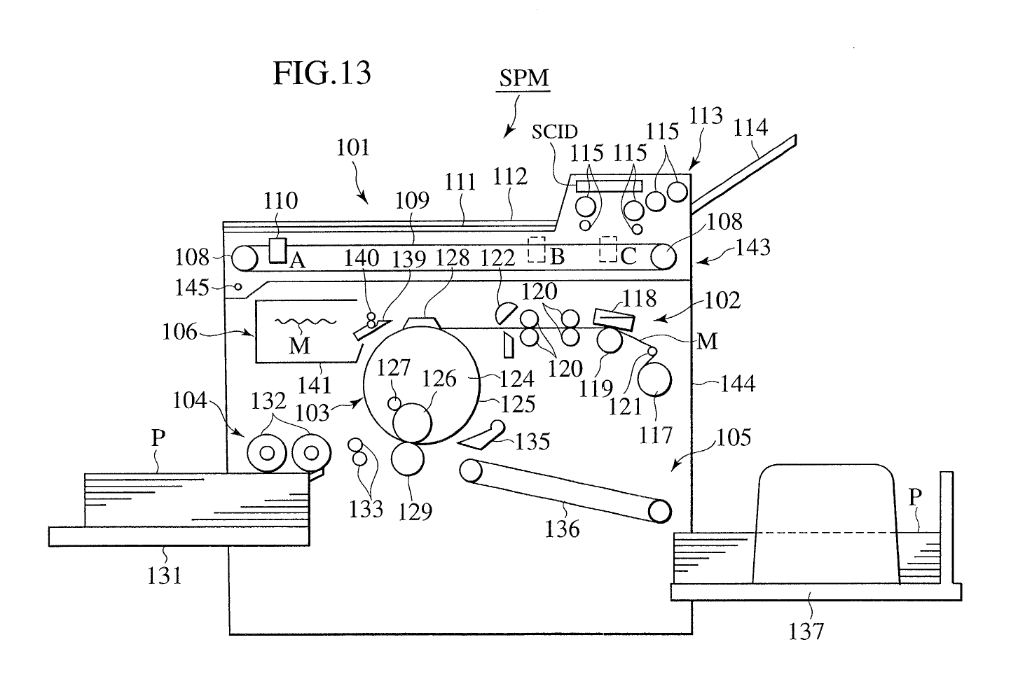

The setup condition input device SCID of the present invention is applied to an image forming apparatus such as, for example, a stencil printing machine SPM sown in FIG. 13.

As shown in FIG. 13, the stencil printing machine SPM includes an original read out section 101, a stencil making section 102, a print section 103, a paper feed section 104, a sheet discharge section 105 and a stencil disposal section 106.

The original read-out section 101 is located in an upper portion of the stencil printing machine SPM to enable an original in bound form (hereinafter referred to as a book original) or a sheet of an original (hereinafter referred to as a sheet original) to be read out.

In order to read out in the book original or the sheet originals one by one, the read-out section 101 is constructed of a moving mechanism which includes a roller pair 108, an endless belt 109 wound on the roller pair 108 and a line image sensor 110 carried by and moveable with the moving mechanism in left or right directions in FIG. 13, an original retainer glass plate 111 on which each of the originals is placed, and a pressure plate 112 which is mounted on the retainer glass plate 111 and is allowed to be opened or closed.

During reading out each of the originals, the book original or the sheet original are placed on the original retainer glass plate 111 with a surface to be read out being placed downward and urged by the pressure plate 112.

Subsequently, the line image sensor 110 is moved. In this event, the line image sensor 110 is moved at a given speed from a home position A to a scan end position B while scanning the original. In such a scanning process, an image of the original placed on the original retainer glass plate 111 is read out as shown FIG. 13.

Also, the stencil printing machine SPM includes an automatic original feeder 113 which allows a plurality of sheets to be sequentially read out one by one. The automatic original feeder 113 includes an original setup tray 114 on which a stack of original sheets are placed. The original sheets placed on the original setup tray 114 are fed into the automatic original feeder 113 one by one with plural transfer rollers 115. During such a sheet transfer, further, the line image sensor 110 is moved to a position C directly below the automatic original feeder 113 and fixed in place by the aforementioned moving mechanism. Thus, this arrangement allows the image of the original, which has been transferred for scanning, to be read out. After reading out of the original sheet has been terminated, the original sheet is fed over the pressure plate 112 that is located outside the automatic original feeder 113.

The stencil making section 102 includes a stencil sheet roll section 117 which has a roll of thermoplastic stencil sheet M in a continuous form, a thermal print head 118 having a plurality of thermal pointer-shaped heating elements which are laterally located in a row, a platen roller 119 located in opposed relationship relative to the thermal head 118, plural stencil sheet feed roller pairs 120 and a stencil sheet cutter 122.

The stencil making section 102 functions to pull out the stencil sheet M from the stencil sheet roll section 117, and rotation of the platen roller 119 allows the stencil sheet, which is sandwiched between the thermal print head 118 and the platen roller 119,to be fed. Further, an image data related to the image of the original, which has been read out with the aforementioned line image sensor 110, is inputted to the thermal print head 118. The thermal print head 118 discretely actuates selected ones of the pointer-shaped thermal print elements in accordance with the image data, thereby thermally perforating the stencil sheet M in a dot-matrix configuration to make a perforated stencil sheet. A stencil sheet guide roller 121 functions to exert a tension to the stencil sheet M at a desired value during transfer thereof between the thermal print head 118 and the platen roller 118. The plural stencil sheet feed roller pairs 120 transfer the perforated stencil sheet M toward the print section 103. Also, the perforated stencil sheet M is cut for one stencil making cycle.

The print section 103 includes a printing drum 124. The printing drum 124 includes a cylindrical circumferential wall 125 made of an ink permeable porous sheet and is rotated counter-clockwise around the central axis thereof as viewed in FIG. 13. Inside the circumferential wall 125, an ink supply unit is located to supply ink to an inner periphery of the circumferential wall 125. The ink supply unit is essentially constructed of a squeegee roller 126 and a doctor rod 127. A part of an outer circumferential periphery of the printing drum 124 carries a stencil sheet clamp segment 128 which clamps a distal end of the perforated stencil sheet M fed from the stencil making section 102. The perforated stencil sheet M, which has been clamped with the stencil sheet clamp segment 128, is wound on and mounted to an outer circumferential periphery of the circumferential wall 125 due to rotation of the printing drum 124.

Further, the print section 103 includes a press roller 129 with its axis aligned parallel to the central axis of the printing drum 124. The press roller 129 is substantially moved upward or downward with a drive unit (not shown) to assume an operative or press engagement position wherein the press roller 129 is held inn press engagement with the outer circumferential periphery of the printing drum 124 and an inoperative position wherein the press roller 129 is separated from the outer circumferential periphery of the printing drum 124. When the press roller 129 remains in the aforementioned press engagement position, a print sheet P is pressurized to the perforated stencil sheet M wound around the outer circumferential periphery of the printing drum 124. Thus, when the inner circumferential periphery of the circumferential wall 125 is supplied with ink from the ink supply unit, the ink is transferred through a perforated area of the perforated stencil sheet M and the ink permeable area of the circumferential wall 125 to the print sheet P to reproduce a desired image pattern thereon.

The paper feed section 104 includes a paper feed tray 131 on which plural print sheets P are stacked prior to printing operation. The print sheets P stacked on the paper feed tray 131 are sequentially removed one by one with paper feed roller pair 132. Further, the print sheet P, which has been removed, is then fed by a timing roller pair 133 that rotates in synchronism with rotation of the printing drum 124 and is subsequently transferred to a position between the printing drum 124 and the press roller 129 at a given timing.

The sheet discharge section 105 includes a sheet separator claw 135 which separates the print sheet P, printed at the print section 103, from the printing drum 124. The printed sheet P separated from the printing drum 124 is then transferred to a paper receiving tray 137 with a paper delivery unit 136 of a conveyer belt type. The printed sheets P are sequentially stacked on the paper receiving tray 137 with their printed image patterns being placed upward.

The stencil disposal section 106 includes a stencil sheet separating claw 139 which allows the perforated stencil sheet M which has previously been mounted onto the outer circumferential periphery of the printing drum 124, to be separated from the printing drum 124. During peeling off the perforated stencil sheet M from the printing drum 124, the clamping operation of the stencil sheet clamp segment 128 is released to cause the perforated stencil sheet M to be released such that a distal end of the perforated stencil sheet M, which has been opened with rotation of the printing drum 124, is hooked with the stencil sheet separating claw 139. The perforated stencil sheet M hooked with the stencil sheet separating claw 139 is peeled off from the outer circumferential periphery of the printing drum 124 owing to its consecutive rotation thereof. The perforated stencil sheet M peeled off with the stencil sheet separating claw 139 is then transferred through a stencil discharge roller pair 140 and is finally received in a stencil disposal box 141.

Such structured stencil printing machine SPM operates using conditions for making stencil sheets and printing, which are stored into and read out from the setup condition input device SCID.

That is, in the preferred embodiment, the stencil printing machine reads out the original on the basis of the image reproducing conditions through the setup condition input device, which has been discussed above, for making the perforated stencil sheet. The perforated stencil sheet is then used for implementing a print of the image to be reproduced on the basis of the image reproducing conditions.

In addition, the stencil printing machine SPM may include an interface function (not shown) to be connected to a personal computer, thereby allowing the image data, which has been produced on the basis of a document preparing application program in the personal computer (not shown) which is locally or globally connected via a communication system, to be received, with the received image data being used for making a perforated stencil sheet while developing pages.

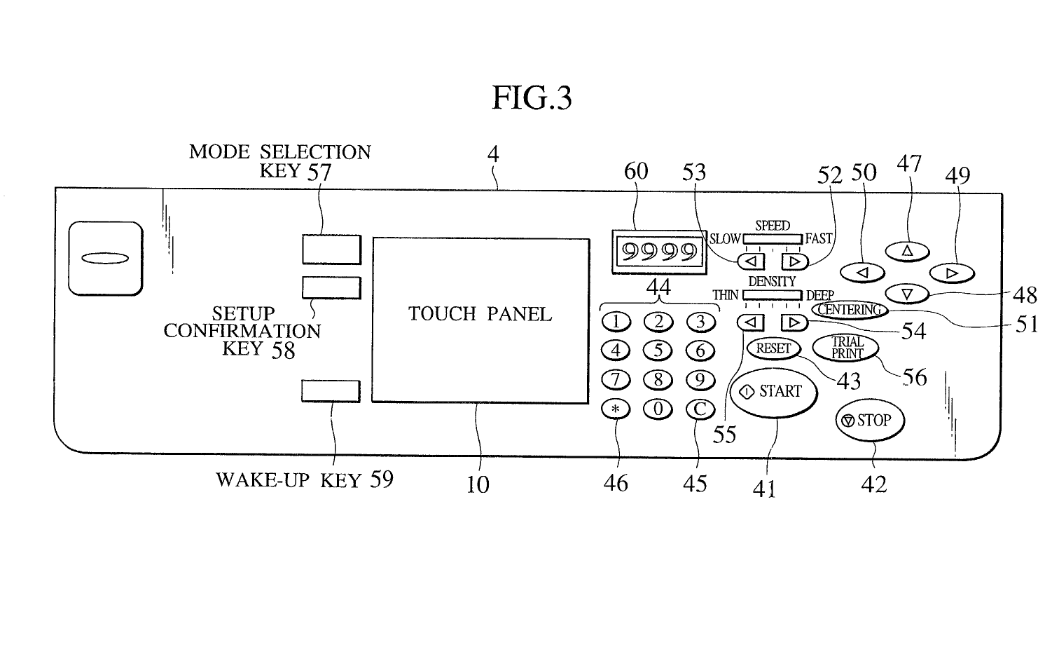

FIG. 3 shows an example of a layout of the operation panel 4 which incorporates the setup condition input device SCID and which is applied to the image forming apparatus such as the stencil printing machine shown in FIG. 13. An upper surface of the operation panel 4 has a layout formed with a touch panel 10 fixed to a front face of a liquid crystal display device, various keys and LED, etc. The operation panel 4 has a start key 41, a stop key 42, a reset key 43 for resetting the setup conditions, function keys 45 and 46, a trial print key 56, print position adjustment keys such as adjusting keys 47 to 50 which allow a print position to be adjusted, a centering key 51 for the print position, speed control keys 52 and 53 for varying the printing speed, adjusting keys 54 and 55 for adjusting the density of the print color, a trial print key 56, a mode selection key 57, ten keys 44 for setting up the number of print sheets to be printed, a setup confirmation key 58 for displaying the setup confirmation screen, and an incremental count value indicating section 60.

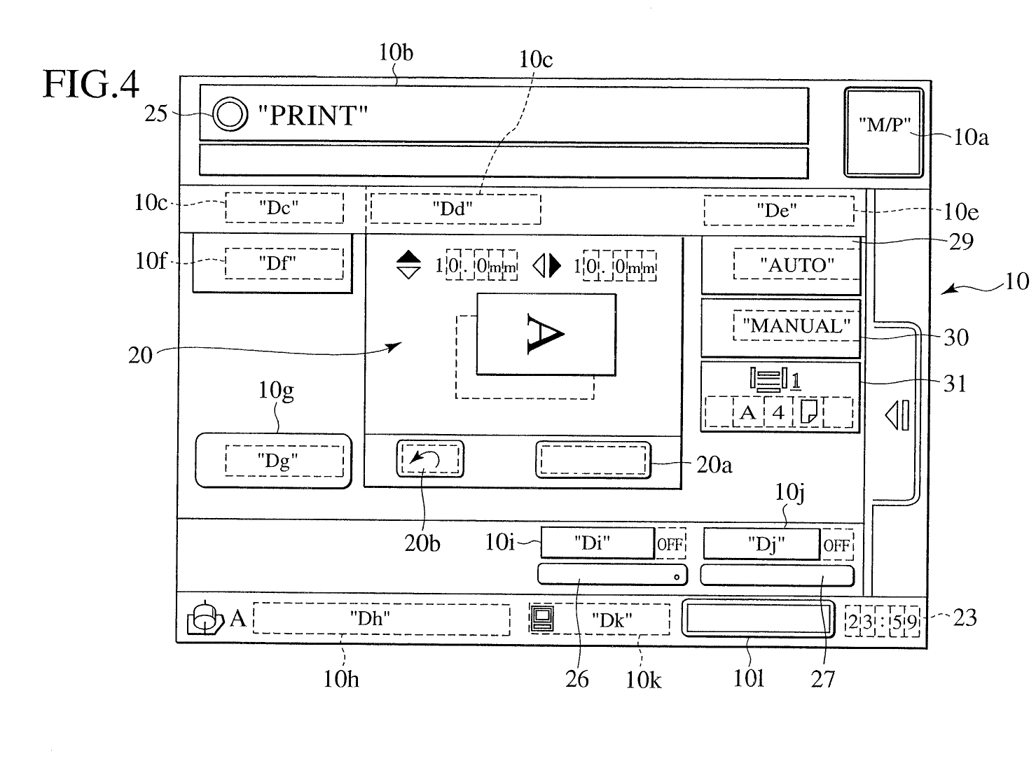

As previously discussed above, the touch panel 10 has the discrete setup screens that are developed in the multi-stage for allowing various parameters to be set up. An example of a basic setup screen is shown in FIG. 4. In this setup screen, for example, there exists a setup key 26 for setting up a sorter function, a setup key 27 for setting up a continuous photograph/continuous printing function, and an adjusting section 20 for finely adjusting the print position. An example of items which can be setup through the setup screen is listed below in Table 1.

TABLE 1

| Image Processing Items | Printing/Operation Items |
|---|---|
| 1. Original mode (character/ | 1. Continuous |
| photo/character and photo) | |
| 2. Halftone/contrast emphasis | 2. Number of print sheets |
| 3. Readout density | 3. Adjustment of print position |
| 4. Setup for magnification | 4. Print speed |
| 5. Continuous photograph | 5. Print density |
| 6. Book mode | 6. Setup sorter |
| 7. Layout original | 7. Double feed detection |
| 8. Setup for ADF binding margin | 8. Fine adjustment of print position |
| 9. Select for tone-curve | 9. Setup for jump wing |
| 10. Stencil making with mirror | 10. Adjustment for fence of |
| image | paper receiving tray |

In the above Table 1, image processing items to be setup are listed in left side and printing/operation items to be setup are listed in left side. Also, these items, which can be setup, is reset by pressing the reset key 56 on the operation panel 4.

In FIG.4, furthermore, the touch panel 10 has a mode selector key 10a located on the touch panel 10 for selecting “a stencil making mode and a print mode (M/P)”, a selected mode indicator section 10b wherein a display of “a printing is enabled” is provided inn FIG. 4, an indicator section 10c for indicating “Command (Dc)”, an indicator section 10d for indicating Print position (Dd)”, an indicator section 10e for indicating “Print sheet (De)”, and a switch 10f for enabling and displaying “Re-making stencil sheet (Df)”, a switch 10 g for which allows only information inputted by the operator through the input device to be effective while preventing other input information delivered through an on-line to be applied and which provide a display of “Exclusive (Dg)”, an indicator section 10h for indicating “the size of the print sheet and the print color (Dh)”, an indicator section 10i for indicating “the operation mode of the sorter (Di)”, an indicator section 10j for indicating “a continuous or discontinuous mode (Dj)”, an indicator section 10k for indicating “Printing waited (Dk)”, a remaining sheet confirmation key 101, a counter display section 23 for indicating a numerical count value, an LED 25, a sorter function selection key 26, a continuous photograph/continuous print mode selection key 27, an auto-mode selection key 29, a manual-mode selection key 30, and a sheet size indicator section 31. The fine adjusting section 20 includes a fine adjusting key 20a for finely adjusting the print position and a return key 20b.

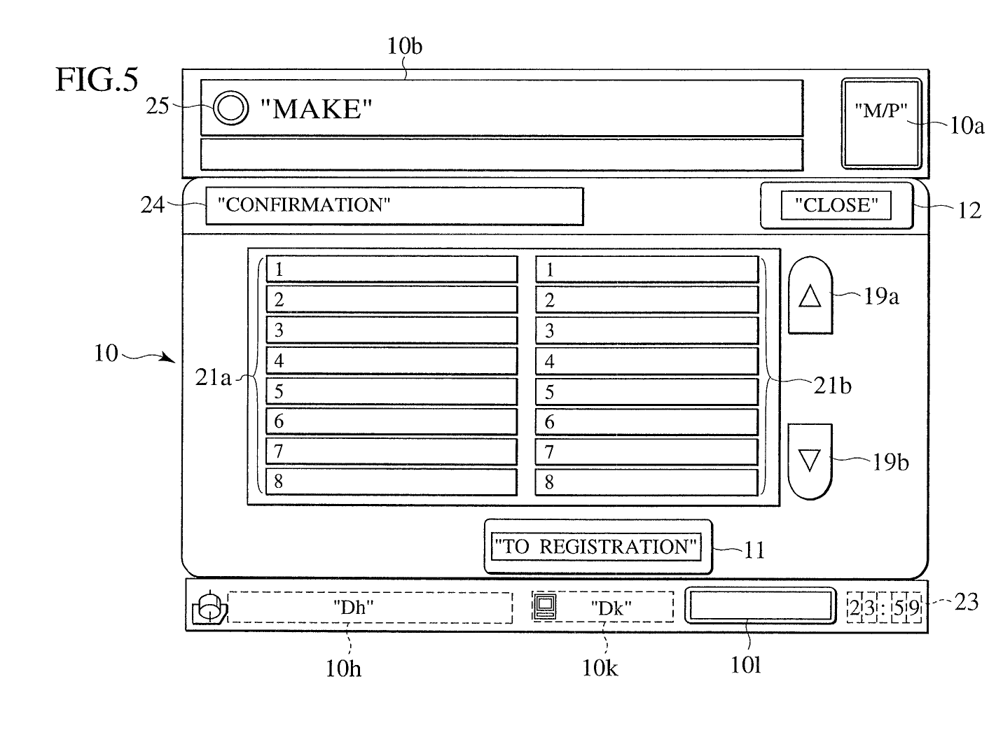

FIG. 5 shows an example of a layout of the setup data recognition screen with the touch panel 10 showing that the selected mode indicator section 10b is in “the stencil making mode” that is selected, with like parts or elements bearing like reference numerals as those used in FIG. 4. The setup confirmation screen includes scroll control buttons 19a and 19b for scrolling the contents upward or downward, an item content display section 21a, a set value display section 21b, a closure button 12 for closing the setup confirmation screen, and a selected operation mode display section 24 for displaying a selected operation mode and indicating in FIG. 5 that the setup confirmation mode is selected.

A relationship between the item content display section 21a and the set value display section 21b is exemplarily listed in the following Table 2.

TABLE 2

| Item content | Set value content |
|---|---|
| 1. Original mode | Photo |
| 2. Magnification | 141% |
| 3. Continuous mode | On |
| 4. Sorter mode | On |
| 5. Number of print sheet | 500 sheets |
| 6. Adjustment for print position | Upper margin with 5.0 |
| | Right margin with 1.5 |
| 7. Tray selection | Tray 1 |
| 8. Print density | Density grade 5 |

As shown in Table 2, the item content and the set value content involve various functions and parameters necessary for properly achieving the stencil making operation. The setup confirmation screen is enabled to appear by depressing the setup confirmation key 58 on the operation panel 4 (see FIG. 3). In the setup confirmation screen, the various items, which have been discretely setup through the respective setup screens, can be displayed such that one item involving the item content 21a and the associated set value 21b is displayed with the display of eight lines (eight items) on one screen. Other items, which does not appear on the aforementioned screen, can be displayed by touching the scroll control buttons 19a and 19b to allow the screen to scroll to provide a display one by one line. Further, the setup confirmation screen has a memory registration button 11 which functions as a memory registration command section which, when depressed, allows the setup conditions and the set values, which are displayed on the screen, to be registered in the memory. By touching the memory registration button 11, the memory registration screen is allowed to appear. Accordingly, the operator is enabled to command the memory registration while looking over the item contents and the set values displayed on the setup confirmation screen.

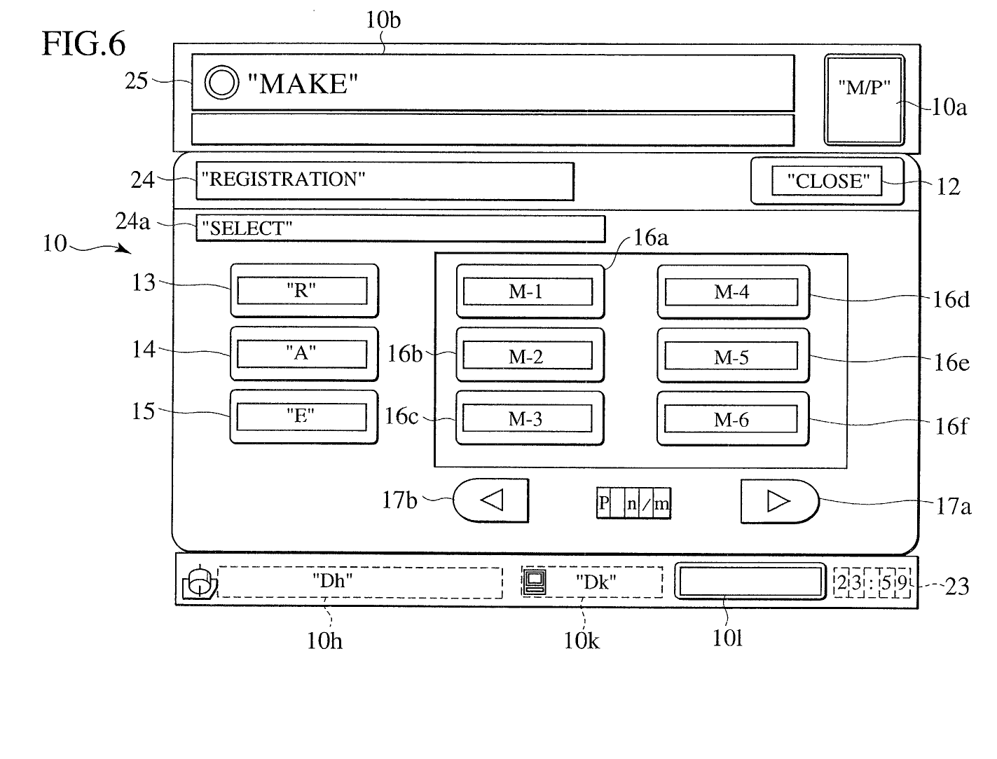

FIG. 6 shows an example of a layout of the memory registration screen, with like parts or elements bearing the same reference numerals as those used in FIG. 5. In the selected operation mode display section 24 indicates that the memory registration mode is selected, with a memory mode display section 24a providing a display “Select memory to be registered”. The memory registration screen has a closure button 12 for closing the memory registration screen, a registration button (R) 13 which allows the setup conditions and the set values to be stored in the selected memory as new information, a title alteration button (A) 14 which allows the title of the previously registered information to be altered, an erasure button (E) 15 which allows the previously stored information to be erased, memory buttons 16a to 16f which allow the setup conditions and the set values to be allocated to respective memories before the setup conditions and the set values are registered, and scroll control keys 17a and 17b for scrolling the memory buttons M-1 to M-6 to provide a selected memory to enable the setup conditions and the set values to be registered therein.

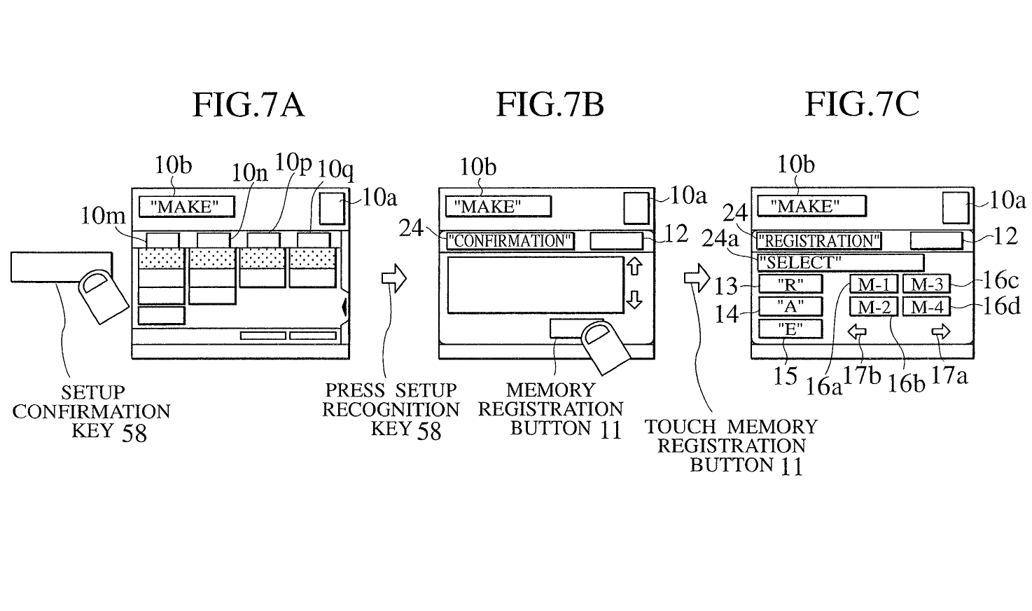

Now, operation of memory registering/call-up process will be described in detail below with reference to FIGS. 7A to 11B.

FIGS. 7A to 7C show the basic sequence of operations that cause shifting from the setup screen shown in FIG. 7A to the memory registration screen shown in FIG. 7C via the setup confirmation screen shown in FIG. 7B, typically in stencil making process. In the setup screen shown in FIG. 7A, an initial setup is executed to set stencil making conditions such as the original mode 10m, the magnification 10n, the print density 10p and the print sheet 10q, etc. After the stencil making conditions have been completely set, the setup confirmation key 58 on the operation panel 4 is pressed, causing the setup content confirmation screen to appear shown in FIG. 7B. In the setup confirmation screen shown in FIG. 7B, the display section 24 indicates a display of “Confirm setup conditions”. When it is contemplated to suitably confirm the stencil making conditions set up through the setup confirmation screen and to register these contents in the memory, the operator presses the memory registration button 11 located on the setup confirmation screen, allowing the memory registration screen to appear as shown in FIG. 7C. In the memory registration screen shown in FIG. 7C, a display section 24 indicates a display of “Register in memory”. By using this memory registration screen, the stencil making conditions and the set values therefore can be registered in a manner as will be discussed below.

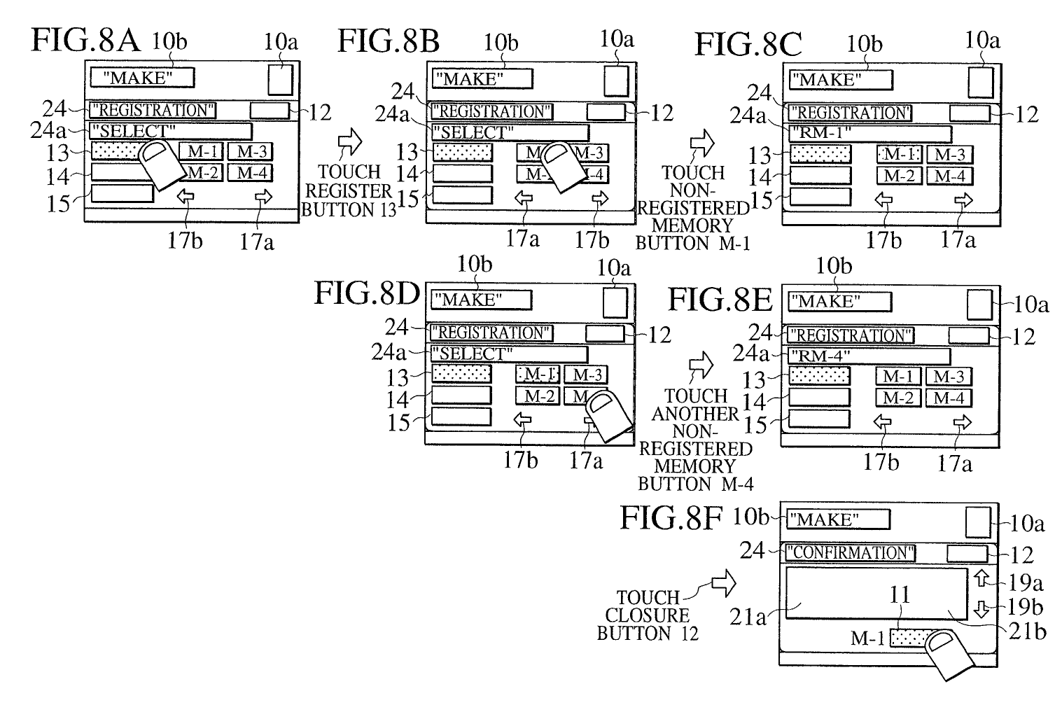

FIGS. 8A to 8F are schematic views illustrating the basic sequence of operations for executing the registration of the stencil making conditions into the selected memories of the memory registration screen. When the memory registration screen appears as shown in FIG. 8A, the memory registration button 13 is initially touched and, among the memory buttons, non-registered memory button (here, the memory button M-1) is then suitably selected and touched (see FIG. 8B). Then, the stencil making conditions are allocated in the selected memory M-1 and registered therein (see FIG. 8C), with a display of “Registered in memory M-1 (RM-1)” at the memory mode display section 24a.

Among the memory buttons, if another non-registered memory button (i.e., the memory button M-4) is selected and is touched as viewed in FIG. 8D, then the stencil making conditions are allocated in the memory button M-4 and is registered therein as viewed in FIG. 8E, with a display of “Registered in memory M-4 (RM-4)” at the memory mode display section 24a.

Further, during registering operation in the selected memory button as viewed in FIG. 8C, if the closure button 12 on the memory registration screen is touched, then the setup confirmation screen appears as viewed in FIG. 8F, with a display “Setup confirmation” at the display section 24 on the screen.

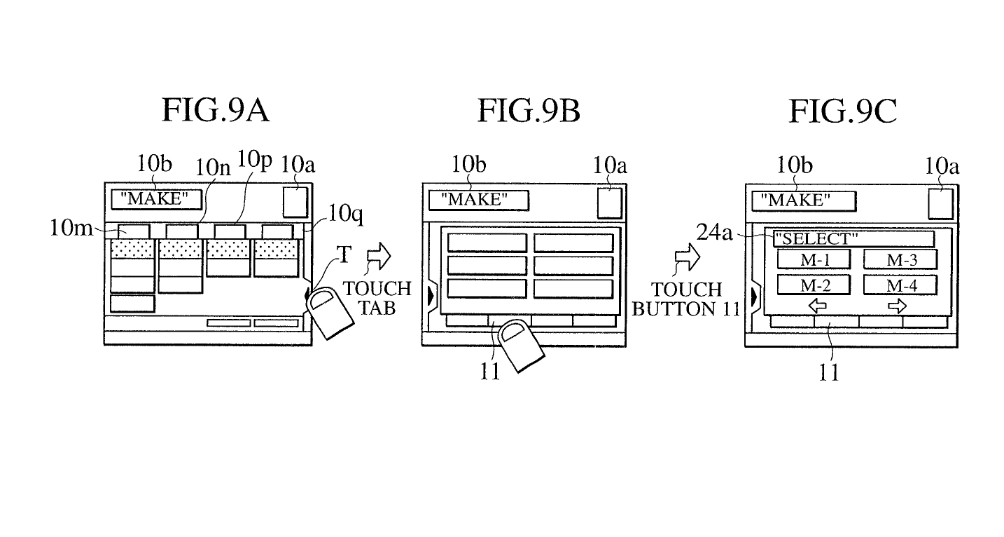

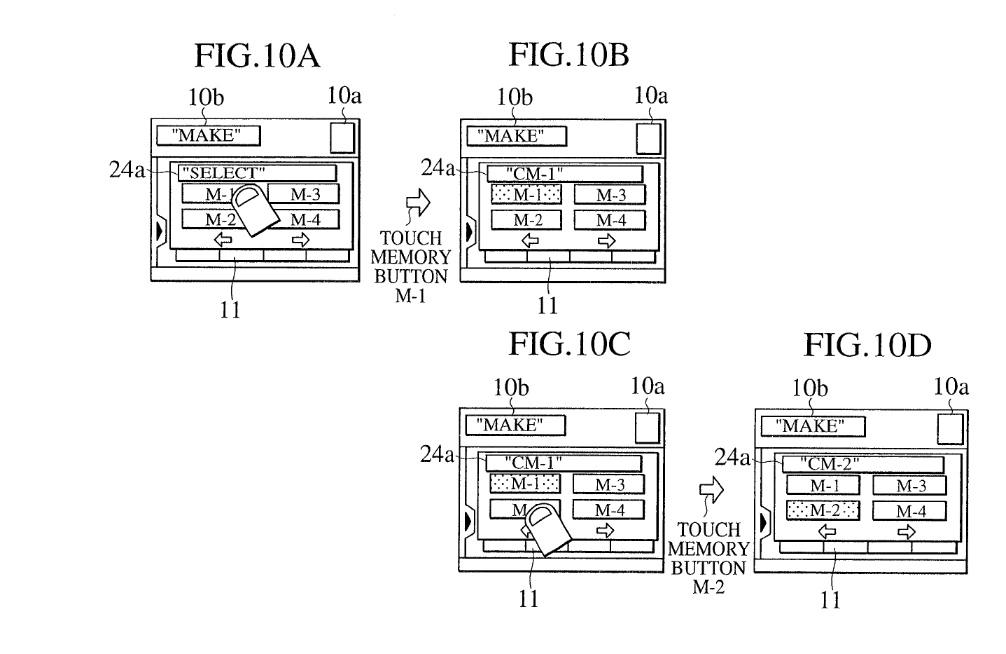

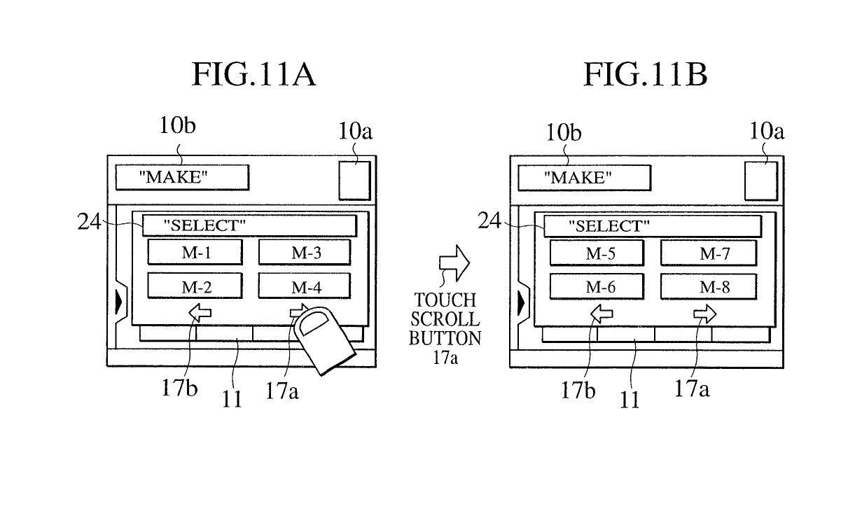

FIGS. 9A to 9C, FIGS. 10A to 10D and FIGS. 11A and 11B are schematic views illustrating the basic sequence of operations of a memory call-up operation for calling up the setup conditions and the set values registered in the selected memories for reuse. When a memory call-up tab T is initially touched to call up the memory from an arbitrary screen as viewed in FIG. 9A, then the call-up screen appears as viewed in FIG. 9B. Subsequently, when the memory registration button 11 is touched, the memory call-up screen appears as viewed in FIG. 9C.In this event, when the memory button (i.e., the memory button M-1), whose registration has been completed, is suitably selected from among the memory buttons and is touched as viewed in FIG. 10A, the memory button M-1 is called up as viewed inn FIG. 10B to allow information that has been allocated and registered in the memory button M-1 to be called up, with the display Memory M-1 is called up (CM-1)″ at the memory mode display section 24a. When another memory button (i.e., the memory button M-2) is selected and is touched as viewed in FIG. 10C, the memory button M-2 is called up as viewed in FIG. 10D to allow information that has been allocated and registered in the memory button M-2 to be called up, with the display Memory M-2 is called up (CM-2)″ at the memory mode display section 24a. Also, operation of the scroll buttons 17a and 17b allows the page of the memory call up screens to be shifted as viewed in FIGS. 11A and 11B, with the display “Select memory” at the memory mode display section 24a.

It will now be appreciated from the foregoing description that, in accordance with the present invention, since the setup condition input device is so arranged as to execute registration of the memories through the setup confirmation screen on which all items of the setup conditions are displayed in a package, it is possible for the operator to fully recognize the content and meaning of the various parameters setup by himself and to allow the operator to register those parameters without causing errors.

In particular, in the image production machine such as the stencil printing machine which allows separate stencil sheets to perform a multi-color printing, since various setup patterns are required in dependence on the king of print sheets and the extremely highly accurate set values such as for print position, etc., are required, it is highly advisable for the operator to execute registration of the above parameters after the contents and the meanings of the various parameters setup by himself has been fully recognized.

While foregoing description of the preferred embodiment of the invention has been presented to illustrate the principles of the invention, the present invention is not limited to the particular embodiment illustrated and various other changes or modifications may be made without departing from the scope of the present invention.

For example, although, in the illustrated embodiment, the setup condition input device has been shown and described as applied to the image reproduction device such as the stencil printing machine, the present invention is not limited thereto. For example, the setup condition input device may be applicable to other machines or devices which have a setup input function in a multi-stage type, such as PDAs (Personal Digital Assistants), telephones, information home appliances, etc.

The entire content of a Patent Application No. TOKUGAN 2000-167769 with a filing date of Jun. 5, 2000 in Japan is hereby incorporated by reference.

Although the invention has been described above by reference to a certain embodiment of the invention, the invention is not limited to the embodiment described above. Modifications and variations of the embodiment described above will occur to those skilled in the art, in light of the teachings. The scope of the invention is defined with reference to the following claims.

What is claimed is:

1. A setup condition input device comprising:
a setup screen of a multi-stage type allowing predetermined conditions to be set up;
a setup confirmation screen allowing the predetermined conditions set up through the setup screen to be displayed in a package for confirmation; and
a memory registration command section allowing the predetermined conditions confirmed through the setup confirmation screen to be stored in memories,
wherein the memory registration command section is located on the setup confirmation screen.

2. A setup condition input device according to claim 1, wherein the setup condition input device is a touch panel type input device including a display section displaying predetermined information and a touch panel located on a front face of the display section.

3. A setup condition input device according to claim 1, wherein the setup confirmation screen has a display section displaying item contents of the predetermined conditions set up through the setup screen and associated set values thereof, and a scroll button selectively displaying the item contents and the associated set values.

4. A setup condition input device according to claim 3, wherein the setup confirmation screen has a first display section to provide a display of the item contents of the predetermined conditions set up through the setup screen and a second display section to provide a display of the associated set values in correspondence with the first display section.

5. A setup condition input device according to claim 1, wherein a memory registration screen is provided to include a plurality of memory buttons allowing the predetermined conditions confirmed through the setup confirmation screen to be stored in a memory that is corresponding one of the plurality of memory buttons, and the setup confirmation screen is shifted to the memory registration screen while the memory registration command section being operated.

6. A setup condition input device according to claim 5, wherein the predetermined conditions confirmed through the setup confirmation screen are stored in the memory through the memory registration screen.

7. A setup condition input device according to claim 1, wherein a memory call-up command section is provided to execute call-up of the predetermined conditions stored in the memories for use.

8. A setup condition input device according to claim 7, wherein a memory call-up command section is appeared while the memory call-up command section being operated.

9. An image forming apparatus comprising:
a setup condition input device provided with:
a setup screen of a multi-stage type allowing predetermined conditions to be set up;
a setup confirmation screen allowing the predetermined conditions set up through the setup screen to be displayed in a package for confirmation; and
a memory registration command section allowing the predetermined conditions confirmed through the setup confirmation screen to be stored in memories, the memory registration command section being located on the setup confirmation screen; and
an image forming unit forming image on basis of the predetermined conditions stored in the setup condition input device and read out thererfrom.

10. An image forming apparatus according to claim 9, wherein the image forming apparatus is a stencil printing machine including a stencil making section making the image data in a stencil sheet to form a perforated stencil sheet on the basis of the image reproducing conditions set up through the setup condition input device, and a print section executing print on the basis of the image reproducing conditions with the use of the perforated stencil sheet.

11. An image forming apparatus according to claim 9, wherein the setup condition input device is a touch panel type input device including a display section displaying predetermined information and a touch panel located on a front face of the display section.

12. An image forming apparatus according to claim 9, wherein the setup confirmation screen has a display section displaying item contents of the predetermined conditions set up through the setup screen and associated set values thereof, and a scroll button selectively displaying the item contents and the associated set values.

13. An image forming apparatus according to claim 12, wherein the setup confirmation screen has a first display section to provide a display of the item contents of the predetermined conditions set up through the setup screen and a second display section to provide a display of the associated set values in correspondence with the first display section.

14. An image forming apparatus according to claim 9, wherein a memory registration screen is provided to include a plurality of memory buttons allowing the predetermined conditions confirmed through the setup confirmation screen to be stored in a memory that is corresponding one of the plurality of memory buttons, and the setup confirmation screen is shifted to the memory registration screen while the memory registration command section being operated.

15. An image forming apparatus according to claim 14, wherein the predetermined conditions confirmed through the setup confirmation screen are stored in the memory through the memory registration screen.

16. An image forming apparatus according to claim 9, wherein a memory call-up command section is provided to execute call-up of the predetermined conditions stored in the memories for use.

17. An image forming apparatus according to claim 16, wherein a memory call-up command section is appeared while the memory call-up command section being operated.
